(19) United States
(12) Patent Application Publication
(10) Pub. No.: US 2026/0292599 A1
(43) Pub. Date: Sep. 24, 2026

(54) METHOD AND APPARATUS TO IMPROVE PACKET DELIVERY IN DC DEPLOYMENTS

(71) Applicant: Samsung Electronics Co., Ltd., Suwon-si, Gyeonggi-do (KR)

(72) Inventors: Morteza KHEIRKHAH, Chertsey (GB); Jonas SEDIN, Chertsey (GB)

(21) Appl. No.: 19/472,606

(22) PCT Filed: Apr. 3, 2024
(86) PCT No.: PCT/KR2024/004340

§ 371 Date: Oct. 3, 2025

(30) Foreign Application Priority Data
Apr. 5, 2023 (GB) 2305074.3

(51) Int. Cl. H04W 28/08; H04W 28/06; H04W 28/088

(52) U.S. Cl. CPC H04W 28/0983; H04W 28/06; H04W 28/088

(57) ABSTRACT

The present disclosure relates to a 5G communication system or a 6G communication system for supporting higher data rates beyond a 4G communication system such as long term evolution (LTE). A method performed by a master node (MN) in wireless communication system and MN are provided. The method may comprise identifying whether to stop splitting one or more traffics towards a secondary node (SN) based on a received feedback message. The method may comprise in case that the feedback message indicates connection between a user equipment (UE) and the SN in poor condition, stopping splitting the one or more traffics towards the SN.

### TECHNICAL FIELD

The present disclosure relates to a telecommunications network, for example to Multi-RAT Dual Connectivity (MR-DC).

### BACKGROUND ART

Considering the development of wireless communication from generation to generation, the technologies have been developed mainly for services targeting humans, such as voice calls, multimedia services, and data services. Following the commercialization of 5G (5 th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6 th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collison avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mecahnisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems.

In addition, services such as remote surgery for security and reliability enhancement, industrial automation, and emergency response will be provided through the 6G communication system such that the technologies could be applied in various fields such as industry, medical care, automobiles, and home appliances.

### Disclosure of Invention

### Solution to Problem

According to an embodiment of the present disclosure, a method performed by a master node (MN) in wireless communication system is provided. The method may comprise identifying whether to stop splitting one or more traffics towards a secondary node (SN) based on a received feedback message. The method may comprise in case that the feedback message indicates connection between a user equipment (UE) and the SN in poor condition, stopping splitting the one or more traffics towards the SN.

According to an embodiment of the present disclosure, a master node (MN) in wireless communication system is provided. The MN may comprises at least one transceiver, and at least one processor coupled to the at least one transceiver. The at least one processor may be configured to identify whether to stop splitting one or more traffics towards a secondary node (SN) based on a received feedback message; and The at least one processor may be configured to stop splitting the one or more traffics towards the SN, in case that the feedback message indicates connection between a user equipment (UE) and the SN in poor condition.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 illustrates a control plane architecture for EN-DC (left) and NR-DC with 5GC (right), according to an embodiment of the present disclosure;

FIG. 2 illustrates a network side protocol termination options for MCG, SCG and split bearers in MR-DC with 5GC (NGEN-DC, NE-DC and NR-DC), according to an embodiment of the present disclosure;

FIG. 3 illustrates a Radio Protocol Architecture for MCG, SCG and split bearers from a UE perspective in MR-DC with 5GC (NGEN-DC, NE-DC and NR-DC), according to an embodiment of the present disclosure;

FIG. 4 illustrates a network side protocol termination options for MCG, SCG and split bearers in MR-DC with EPC (EN-DC), according to an embodiment of the present disclosure;

FIG. 5 illustrates a Radio Protocol Architecture for MCG, SCG and split bearers from a UE perspective in MR-DC with EPC (EN-DC), according to an embodiment of the present disclosure;

FIG. 6 illustrates scenarios of dual-connectivity technology with a splitting bearer type (either MCS Split Bearer or SCG Split Bearer); and

FIG. 7 illustrates a flow chart of signaling procedures according to an embodiment of the present disclosure.

FIG. 8 illustrates a user equipment (UE) according to embodiments of the present disclosure.

FIG. 9 illustrates a user equipment (UE) according to embodiments of the present disclosure.

### MODE FOR THE INVENTION

The optional features set out herein may be used either individually or in combination with each other where appropriate and particularly in the combinations as set out in the accompanying claims. The optional features for each aspect or exemplary embodiment of the disclosure, as set out herein are also applicable to all other aspects or exemplary embodiments of the disclosure, where appropriate. In other words, the skilled person reading this specification should consider the optional features for each aspect or exemplary embodiment of the disclosure as interchangeable and combinable between different aspects and exemplary embodiments.

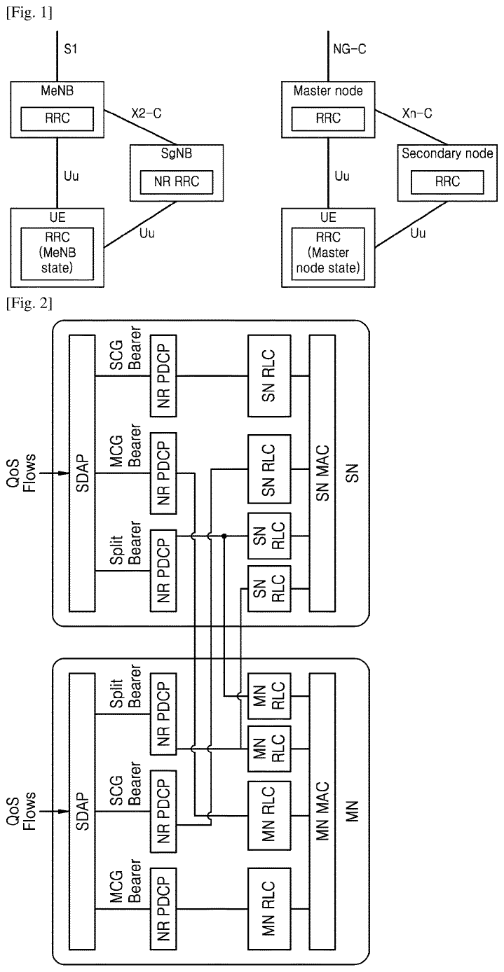

FIG. 1 through FIG. 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the disclosure, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases. cl ACRONYMS
5G Core Network
CPA Conditional PSCell Addition
CPC Conditional PSCell Change
DC Intra-E-UTRA Dual Connectivity
EN-DC E-UTRA-NR Dual Connectivity
MCG Master Cell Group
MN Master Node
MR-DC Multi-Radio Dual Connectivity
NE-DC NR-E-UTRA Dual Connectivity
NGEN-DC NG-RAN E-UTRA-NR Dual Connectivity
NR-DC NR-NR Dual Connectivity
QoE Quality of Experience
QoS Quality of Service
RAN Radio Access Network
RAT Radio Access Technology
RLM Radio Link Monitoring
SCG Secondary Cell Group
SN Secondary Node

Multi-RAT Dual Connectivity (MR-DC) is a general term to describe various Dual Connectivity (DC) scenarios with 5G system. A MR-DC technology permits an end device (e.g., smartphone, tablet, laptop, drone, robot, home broadband router, etc.) to connect to at least two cellular cell towers at the same time, utilizing different frequency bands (e.g., FR1 and FR2). Such a feature automatically provides a high data rate to end devices and flexibility in data transportation, which is an essential re-quirement for 5G and 6G use cases.

Apart from achieving a high data rate, better reliability and lower latency can also be achieved if proper data scheduling and traffic steering mechanisms are in place across these simultaneous, potentially heterogeneous cellular links to handle a diverse set of traffic that may be generated from different 5G/6G applications with distinct requirements and constraints.

There are several ways the MR-DC technology can be realized by the 3GPP system and that is mainly dependent on which 3GPP access and core network technologies are used (e.g., whether the core network is 5GC or EPC, and whether the access network supports eNB or gNB and their variants en-gNB or ng-eNB).

Example of MR-DC configurations include EN-DC (E-UTRA-NR Dual Connectivity), NR-DC (New Radio Dual Connectivity), NGEN-DC (NG-RAN-E-UTRA Dual Connectivity) and NE-DC (NR-E-UTRA Dual Connectivity). Across all deployment configurations, four different main bearer models have been considered by 3GPP. Each bearer model explains how data streams (user plane traffic) between UE and the core network (either EPC or 5GC) can flow through the RAN: (i) Master Cell Group (MCG) Bearer; (ii) MCG Split Bearer, (iii) Secondary Cell Group (SCG) Bearer and (iv) SCG Split Bearer.

In a DC deployment, one of the base stations becomes the Master node (MN) which terminates the core network connectivity. Once UE has been registered/connected to the network via the MN, it can connect to another base station called the Secondary node (SN). The SN can also terminate the core network connectivity, similar to the MN.

FIG. 1 illustrates control plane architecture for EN-DC (left) and MR-DC with 5GC (right), according to an embodiment of the present disclosure.

The MN and SN interact with one another via either X2 or Xn interfaces for ex-changing both user plane and control plane (X2-C and Xn-C) traffic, depending on the deployment scenario (e.g., EN-DC or NR-DC, respectively).

In EN-DC or NR-DC, the UE has a single RRC state based on the MN RRC and a single control plane connection towards the CN. FIG. 4.2.1-1 illustrates the control plane architecture for MR-DC (i.e., EN-DC or NR-DC). Each radio node has its own RRC entity (E-UTRA version if the node is an eNB or NR version if the node is a gNB), which can generate RRC PDUs to be sent to the UE.

The RRC PDUs generated by SN (i.e., SgNB in FIG. 1) can be delivered to UE via the MN (i.e., MeNB in FIG. 1). The MN always transports the initial SN RRC configuration via MCG SRB (SRB1), but subsequent reconfigurations may be transported via MN or SN. When transporting RRC PDUs from the SN to UE via the MN, the MN does not modify the UE configuration provided by the SN.

If the SN is gNB, the UE can be configured to setup SRB3 with which the UE and SN can interact directly without needing to send some of their control plane singling via MN.

Across all MR-DC scenarios, not only user plane but also control plane can be split, permitting duplication of RRC PDUs generated by the MN, via the direct path and via the SN. However, note should be taken that split SRB uses NR PDCP only.

Across all DC scenarios with 5GC, the UE stores the PDCP/SDAP configuration and the SCG configuration when transiting to the RRC INACTIVE state. During connection resumption, if the UE supports resuming with MR-DC, the UE can be configured to release, restore, or reconfigure the SCG configuration. Otherwise, it releases the SCG configuration. In the case of EN-DC, the SCG configuration is kept in the UE during the suspension. During connection resumption, if the UE supports resuming with EN-DC, the UE can be configured to release, restore, or reconfigure the SCG configuration. Otherwise, the UE releases the SCG configuration (not the radio bearer configuration) during resumption initiation.

With NR-DC (New Radio Dual Connectivity), the core network is 5GC and base stations at the radio access network support only 5G New Radio technology (i.e., gNB).

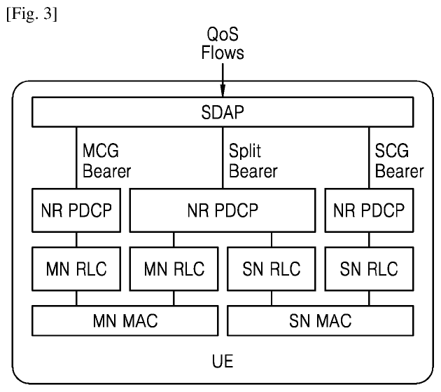

FIG. 2 illustrates network side protocol termination options for MCG, SCG and split bearers in MR-DC with 5GC (NGEN-DC, NE-DC and NR-DC), according to an embodiment of the present disclosure.

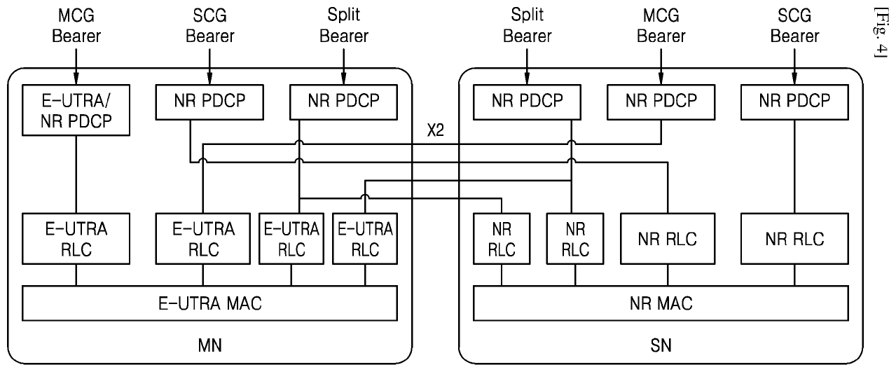

NR-DC deployment with four different bearer models may be provided, as initially discussed in the previous section. With the MCG Bearer model, the core network sends the UE's traffic to the Master Node (MN or MgNB). This way, the traffic is arrived at the SDAP layer of MN (the left box in FIG. 3) and then it is passed down to the PDCP layer and so on. The MCG Split Bearer option follows similarly to the MCG Bearer (arrives at the MN), but it can split the traffic at the PDCP layer of the MN, where some traffic can be delivered to UE via the Secondary node (SN or SgNB).

The connectivity between the MN (MgNB) and the SN (SgNB) is through the Xn interface for carrying both user plane and control plane traffic. The split portion of traffic from MN arrives at the RLC layer of SN (i.e., SN RLC at FIG. 3). The SCG Bearer and the SCG Split Bearer options follow similarly the MCG Bearer and the MCG Split Bearer, respectively.

FIG. 3 illustrates a Radio Protocol Architecture for MCG, SCG and split bearers from a UE perspective in MR-DC with 5GC (NGEN-DC, NE-DC and NR-DC), according to an embodiment of the present disclosure.

FIG. 4 illustrates a network side protocol termination options for MCG, SCG and split bearers in MR-DC with EPC (EN-DC), according to an embodiment of the present disclosure.

A UE can connect to two cellular cells simultaneously. A MN can be a Macrocell, operating at lower frequency bands (e.g., sub-6-GHz; FR1 spectrums), which results in wider coverage. The SN can be a small cell operating at high-frequency bands (e.g., mmWave; FR2 spectrums), which results in a shorter coverage, but it provides extremely high bandwidth to UE.

A bearer model in FIG. 3 can be used for downstream/upstream traffic to/from UE. This traffic can be used for the user plane or control plane. In the case of the control plane traffic, the RRC layer should replace the SDAP layer in FIG. 3. In the case of user plane traffic (i.e., QoS Flows), it is split at NR-PDCP towards two separate NR RLC instances.

The PDCP layer is to provide a sequence ordering of the incoming traffic by generating Protocol Data Unit (PDU), which includes a sequence number in its header from the incoming traffic. This functionality permits the traffic to be reassembled with a correct ordering at the receiver if the PDCP PDUs arrive out-of-order due to the latency mismatch of different RATs involved in a DC scenario or PDU losses at the PHY layer.

With EN-DC deployment, the core network is EPC (Evolved Packet Core) instead of 5GC, and thus, the MN is eNB (MeNB) connecting to EPC. The SN (SgNB) is en-gNB (a gNB that can also support EPC). The SgNB connects to MeNB via the X2 interface, delivering both user plane and control plane traffic.

In MR-DC, the UE has a single RRC state, based on the MN RRC and a single C-plane connection towards the Core Network. FIG. 4.2.1-1 illustrates the Control plane architecture for MR-DC. Each radio node has its own RRC entity (E-UTRA version if the node is an eNB or NR version if the node is a gNB) which can generate RRC PDUs to be sent to the UE.

RRC PDUs generated by the SN can be transported via the MN to the UE. The MN always sends the initial SN RRC configuration via MCG SRB (SRB1), but subsequent reconfigurations may be transported via MN or SN. When transporting RRC PDU from the SN, the MN does not modify the UE configuration provided by the SN.

At initial connection establishment SRB1 uses E-UTRA PDCP. If the UE supports EN-DC, regardless of whether EN-DC is configured or not, after initial connection establishment, MCG SRBs (SRB1 and SRB2) can be configured by the network to use either E-UTRA PDCP or NR PDCP (either SRB1 and SRB2 are both configured with E-UTRA PDCP, or they are both configured with NR PDCP). Change from E-UTRA PDCP to NR PDCP (or vice-versa) is supported via a handover procedure (reconfiguration with mobility) or, for the initial change of SRB1 from E-UTRA PDCP to NR PDCP, with a reconfiguration without mobility before the initial security activation.

If the SN is a gNB (i.e. for EN-DC, NGEN-DC and NR-DC), the UE can be configured optionally to establish a SRB with the SN (SRB3) to enable RRC PDUs for the SN to be sent directly between the UE and the SN. RRC PDUs for the SN can only be transported directly to the UE for SN RRC reconfiguration not requiring any coordination with the MN. Measurement reporting for mobility within the SN can be done directly from the UE to the SN if SRB3 is configured.

UE and NG-RAN can be configured with multiple data bearers simultaneously to handle UE's traffic. For example, it is possible to use the MCG Bearer and the SCG Split Bearer to route a particular set of traffic only via eNB such as Voice traffic while also splitting Internet traffic via both eNB and gNB, at a finer granularity (e.g., at the packet level granularity). This also implies that splitting traffic across different bearer configurations can be done at the network core while splitting traffic through a single MCG/SCG Split Bearer configuration can be performed at the PDCP layer.

Splitting traffic at gNB may be preferred as it has more capabilities compared to eNB. In other words, the SCG Split Bearer may be a more desirable deployment option in an EN-DC deployment (see Option 3x in XXX).

EN-DC is the most common Non-Standalone (NSA) 5G deployment, allowing 5G NR technology to be deployed alongside the 4G infrastructure. There are other deployment variants similar to EN-DC, supporting Multi RAT DC (MR-DC) such as NGEN-DC (NG-RAN-E-UTRA DC) and NE-DC (NR-E-UTRA DC). The latter has a MN with Next Generation eNB (ng-eNB), so-called “Sng-eNB”, while the former has ng-eNB as the Secondary node, so-called “Sng-eNB”. With NGEN-DC and NE-DC the network core is 5GC.

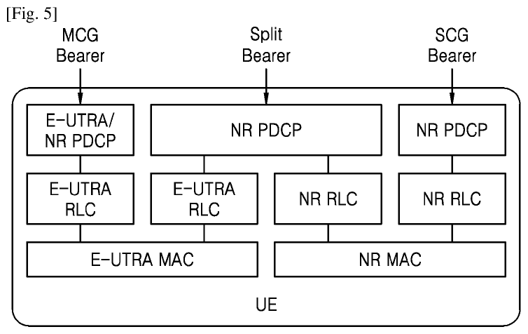

FIG. 5 illustrates a Radio Protocol Architecture for MCG, SCG and split bearers from a UE perspective in MR-DC with EPC (EN-DC), according to an embodiment of the present disclosure. With EN-DC, the MCG bearer could be handled by either E-UTRA PDCP or NR PDCP dependent on the configuration and UE's capability. A Split Bearer (e.g., MCG or SCG split bearer) can only be handled by NR PDCP as splitting is a new functionality of the NR. The SCG bearer should also pass through NR PDCP given that it is destined with Secondary Node which gNB.

According to an embodiment of the present disclosure a network configured for Multi-RAT Dual Connectivity, MR-DC, may be provided. The network may be configured to hold sent PDCP PDUs to the RLC layer at the PDCP layer until delivered at the other side. For example an acknowledgment may be received such as via a PDU status report, regardless of the RLC configuration, for example UM or AM.

According to an embodiment of the present disclosure a network configured for Multi-RAT Dual Connectivity, MR-DC, may be provided. The network may be configured to adjust the discardTimer at the PDCP layer dynamically according to an underlying network condition of the UE and its connectivity to base stations, for example MN or SN.

According to an embodiment of the present disclosure, a network configured for Multi-RAT Dual Connectivity, MR-DC may be provided. The network may be configured to generate a PDCP Status Report message from the receiving PDCP to the other side (e.g., from UE to MeNB), according to a new short timer after which a missing PDCP sequence number in the reception PDCP buffer is detected.

According to an embodiment of the present disclosure, a network configured for Multi-RAT Dual Connectivity, MR-DC, may be provided. The network may be configured to hold extra information regarding the RLC layer each packet (i.e., PDCP PDU) has been forwarded to at the PDCP layer.

According to an embodiment of the present disclosure, a network configured for Multi-RAT Dual Connectivity, MR-DC, may be provided. The network may be configured to trigger removal of backlogged data packets at a radio protocol stack (e.g., Sen-gNB) that have already been retransmitted via the other radio protocol stack (e.g., MeNB).

According to an embodiment of the present disclosure, a network configured for Multi-RAT Dual Connectivity, MR-DC, may be provided. The network may be configured to monitor a size of the RLC transmission buffer and when it exceeds a certain configurable threshold, to send an indication to the PDCP layer indicating that the RLC buffer is building up.

With 5G-NR a transmission buffer is included in the PDCP layer/entity to temporarily hold PDCP SDUs/PDUs until they are submitted to the RLC layer. A discardTimer is provided in 5G-NR to control when these stored PDCP SDUS/PDUs (not yet submitted to RLC) should be removed from the transmit buffer of the PDCP and RLC entity regardless of whether they have arrived at the receiver PDCP entity or not.

It is worth noting that the PDCP PDUs may temporarily be stored in the PDCP layer before submitting them into an RLC layer, but once they are sent down to the lower layer (i.e., the RLC layer), they will be removed from the PDCP's transmission buffer. The same principle holds at the UE side for the uplink traffic. This way, for example, when a Master RAN node (i.e., MeNB, MgNB)sends some PDCP PDUs to the RLC layer of a secondary RAN node (i.e., SgNB), those submitted PDCP PDUs will be removed from the PDCP transmit buffer.

When the PDCP discardTimer expires for a PDCP SDU or the successful delivery of a PDCP SDU is confirmed by the PDCP status report (generated by the UE in the case of DL), the transmitting PDCP entity (i.e., the base station) shall discard the PDCP SDU along with the corresponding PDCP Data PDU. If the corresponding PDCP Data PDU has already been submitted to lower layers, the discard is indicated to lower layers (i.e., PDCP notifies RLC to remove the PDCP PDU from its transmit buffer).

If the “discardTimer” is set to a small value, data PDUs stored in the PDCP and RLC layers may be dropped so quickly, e.g., due to retransmission delays at the MAC layer, perhaps a problematic setting with split bearer scenarios where a RAN node may become simply slow due to poor connectivity, and thus all unacknowledged packets will be discarded, creating unnecessarily end-to-end delays provided that these discarded packets should be retransmitted by the upper for example, the transport and/ or application layers.

Having said that, the advantage of a small “discardTimer” is that it requires a small amount of memory at UE and/or base station to be allocated for the PDCP entity. Also, if the memory allocation is shared across multiple PDCP instances, then an instance with a small discardTimer may not occupy a large memory space, providing headroom for other PDCP instances. On the contrary, when the value of the discardTimer is large, a large amount of memory space should be allocated to the PDCP entity, which may cause the reordering buffer at the receiver entity to build up a long queue quickly, especially in a split bearer scenario where a RAN node may deliver data packets with some delays while the other RAN node can deliver data packets quickly creating sequence number gap in a stream of packets.

Neither having a large (reordering) queue at the receiver nor having a large transmit queue may be a problem. It may become a problem when a packet stays in a queue for a long time. Additionally, having a large discardTimer may also cause a RAN node with poor connectivity to UE attempts to retransmit several packets unnecessarily and if those backlogged packets are removed and retransmitted via other means (e.g., at different layers) the less end-to-end delay may be experienced.

Overall, more retransmission attempts may implicate a longer end-to-end latency because data packets that are already arrived out-of-order at the PDCP layer of the receiver entity may not be delivered to the upper layers until they are reassembled in order or a timer will be eventually triggered to deliver all packets in the reception buffer to the upper layer regardless of their ordering. Additionally, retransmissions at both MAC and RLC imply delaying in sending new packets from the RLC's transmission buffer because the MAC scheduler tends to give a higher priority to re-transmitting lost packets than sending new packets (in the DL direction), which also increases the end-to-end delay even for applications that do not concern about the ordering arrival of their data packets (e.g., UDP flows). Therefore, it is essential to have intelligent mechanisms within the 3GPP RAN to prevent packets from being lost, and if they are lost, then handle them gracefully, causing minimal end-to-end delay. This problem magnifies with DC scenarios, especially with a splitting bearer such as MCG Split Bearer or SCG Split Bearer, where typically a Master RAN node should split traffic at the PDCP layer to at least two RLCs, one of which is located at the Secondary RAN node. This fundamentally hinders inter-RAT retransmission for a set of packets provided that PDCP does not hold any incoming packets that are already sent to an RLC layer (i.e., submitted PDCP PDUs to the RLC layer).

The PDCP layer only discards PDCP SDUs and PDCP PDUs when either it receives an acknowledgment from the receiver or a dicardTimer is expired. The latter case is the worst case, where a set of packets in the PDCP and/or RLC layer may be discarded without confirmation (i.e., received acknowledgement) from the receiver, which implies that laggy end-to-end retransmissions should be performed at the transport layer, perhaps via TCP or MPTCP, to recover those discarded packets. The latter case may be harmful if the discardTimer is set too small for a given condition.

It is important to note that the PDCP layer in 5G-NR has a transmission buffer, but it is used to hold incoming from the upper layer before submitting them to the RLC layer. Even if the PDCP layer holds all packets (i.e., both SDUs and PDUs) in its transmit buffer still, adjusting the discardTimer should not be static as it is with current standard specifications given that on many occasions, a small discardTimer means smaller memory usage, which is crucial for both UE and base stations.

In summary, the following conditions are not desirable in the case of a split bearer scenario, and thus this paper attempts to prevent them proactively: (i) discarding unacknowledged packets at PDCP and/or RLC via a discardTimer with fixed discarding interval without considering underlying network condition of connected links; (ii) re-transmitting packets at the MAC and RLC layers for multiple times, causing a long end-to-end delay and also building up a long queue at the reordering buffer of the receiver.

To elaborate further on the problem described above, let us assume that a UE is EN-DC capable, so it is connected to two heterogeneous base stations (MeNB and Sen-gNB) simultaneously via an MCG Split Bearer that is activated during the UE's initial network attachment. This way, the incoming traffic from EPC (specifically S-GW) splits at the PDCP layer of the MeNB node; some of the traffic goes down the RLC layer of the MeNB, while the other portion of traffic goes towards the RLC layer of the Sen-gNB via the X2 interface.

In such a scenario, the connectivity of UE to Sen-gNB is suddenly deteriorated due to some unexpected interferences and/or loss of signal strength/quality. The latter is a common case when UE is connected to a small cell operating at high-frequency bands where foliage or barrier simply weakens the signal strength. In such a condition, the Sen-gNB suffers from packet losses and thus it may need to retransmit a large number of packets, which practically induces a long end-to-end delay given that the re-transmission attempts may also fail with high probability. Additionally, while the MAC layer is busy with retransmitting lost packets, new incoming packets will be stored in the RLC's transmit queue of Sen-gNB until the RLC transmit queue is overflown. Therefore, new mechanisms are also required to prevent such a buffer from overflowing at the RLC layer under a DC scenario with a split bearer which results in unnecessary packet losses. The RLC buffer may overflow or become full before a discardTimer is triggered. It merely depends on how the discardTimer is configured.

When MeNB detects (or may predict) that the connectivity between Sen-gNB and UE is not (or will not be) in good condition for any reason, it can stop sending additional traffic to the Secondary node (Sen-gNB) although the data volume size is above a splitting threshold value (Note that for UL this is controlled by ulDataSplit-Threshold). However, the Master node (MeNB) cannot do anything regarding the already backlogged packets at the RLC layer (holding PDCP PDUs) and/or the MAC layer (holding RLC PDUs) of Sen-gNB waiting to be transmitted and/or retransmitted, which may take a long time. If MeNB wishes to retransmit those backlogged packets, it first needs to retrieve them via the X2 interface which practically requires a lot of network resources and introduces additional delays.

The key problem here is that the PDCP does not hold PDCP PDUs, which it sent down to the RLC layer of the primary and secondary RAN node. Even if it does, the discardTimer should not be set statically, because the transmit buffer size could be a function of UE's connection quality to base stations.

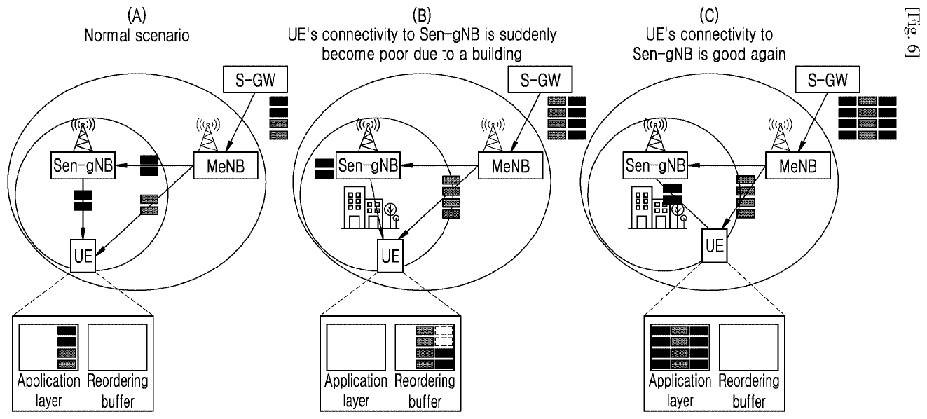

FIG. 6 illustrates scenarios of dual-connectivity technology with a splitting bearer type (either MCS Split Bearer or SCG Split Bearer). Traffic splitting problems of dual-connectivity technology with a splitting bearer type (either MCS Split Bearer or SCG Split Bearer) may occur. FIG. 6 pictures this problem further over a few scenarios. In these scenarios, UE is connected to two base stations (BSs) simultaneously; the first BS is Macrocell, MeNB, with a large signal coverage (shaded green), while the second BS is a small cell, Sen-gNB, operating at high-frequency bands (FR2) with a small signal coverage (shaded gray). The UE's downstream traffic comes from S-GW (EPC) to MeNB and then splits at its PDCP; a portion of traffic is delivered to UE via Sen-gNB (5G NR). The first scenario, (A), shows a normal EN-DC operation where packets are delivered to UE without any issues (i.e., with no severe packet losses, given that UE has good connectivity with both BSs).

However, in the second scenario, (B), UE suddenly entered a residential area with several tall buildings and trees (or suddenly a large vehicle obstructed the connection between our stationary UE and BS or other scenarios), whereby its signal strength towards Sen-gNB became weak. Here, let's assume that MeNB can detect that Sen-gNB has poor connectivity to UE, so it can immediately stop splitting traffic towards Sen-gNB, and thus all new incoming data packets are routed via MeNB to UE.

The key remaining problem, though, is that there are still some packets at Sen-gNB which are not yet been delivered to UE (they are backlogged either at the RLC layer or at the MAC layer). As a result, UE starts buffering/holding packets at a reception/reordering buffer at the PDCP layer until these missing packets are delivered.

In the third scenario, (C), When the UE has got a better signal strength to Sen-gNB (due to removal of interference/barrier or location changes, etc.), those backlogged data packets are delivered to UE whereby packets in the reordering buffer are all in-order and ready to be delivered to the upper layer (FIG. 6 shows 12 packets have delivered to the application layer and the PDCP's reception buffer is empty). It is worth reminding that the weak signal strength is only one reason for creating backlogged packets but all the other reasons (e.g., interference) that cause packet losses at the PHY layer can create backlogged packets at the upper layers.

An aspect of this present disclosure is to allow the backlogged packets at the Sen-gNB node in scenario B, to be detected proactively (perhaps via a predictive mechanism) and then quickly retransmitted via MeNB instead of waiting until UE's connectivity to Sen-gNB is improved by any possible means, which may introduce significant delays. Additionally, the proposed solution tends to prevent the “discardTimer”, or a similar control parameter used in DL, from being triggered. Instead it tries to discard packets only when they are acknowledged by the receiver entity or re-transmitted from another RAN node so that end-to-end retransmissions are not required.

Note: Before packets are delivered to the application layer, they are first forwarded to the transport layer where it may be temporarily stored in another reordering buffer, which is the case with TCP or its variants, ensuring that packets are in-order end-to-end and at the TCP connection level.

A similar problem exists at the UE side with MCG Split Bearer and SCG Split Bearer for the uplink traffic. Like downlink, the uplink traffic of UE splits at the NR PDCP layer towards two different RLCs (as shown in FIG. 5) in the case of EN-DC, which eventually needs to be transmitted via two different PHYs (e.g., E-URTA and NR). In this way, the UE is not capable of moving data packets that have already been sent down from a technology stack to another one at the radio level (e.g., from E-URTA to NR). This implies a significant increase in end-to-end latency, which is not acceptable in many 5G use cases (e.g., URLLC). Additionally, static adjustment of “discardTimer” is a real issue for UL direction given that when it is set to a low-value PDCP and RLC PDUs/SDUs waiting for transmission or retransmission may be dropped so quickly, which then needs to be retransmitted by higher layer such as transport or application layer. When the value of discardTimer is set to be large, then packets may stay in an RLC transmit queue for a long time and that may limit traffic steering functionality as it may be required to retransmit packets that have already transmitted to an RLC instance to another one.

The present disclosure attempts to tackle these shortcomings at both RAN (DL) and UE (UL) when a DC scenario is used with a splitting bearer type.

Note: A split bearer can be configured bi-directionally so that the master and secondary RAN nodes are used for both UE's uplink and downlink traffic.

Embodiments of the disclosure may minimize potential delays when conducting inter-RAT retransmission. This includes minimizing queue length at the reordering buffer of the receiver PDCP entity. Embodiments of the disclosure may prevent discardTimer at the PDCP layer from being triggered poorly to delete unacknowledged packets at the PDCP layer as well as lower layers. Embodiments of the disclosure may quickly retransmit a set of packets from one RAT to another in a DC scenario with MCG/SCG Split Bearer.

The present disclosure describes a set of new mechanisms at the PDCP layer to improve inter-RAT retransmissions for both lost and backlogged packets. The proposed mechanisms can be incorporated in radio protocol stacks of both UE and BSs (e.g., MeNB, en-gNB, gNB, so on). Generally, described herein is a Method and Apparatus to Improve Packet Delivery in DC Deployments.

An embodiment of the present disclosure may include holding the sent PDCP PDUs to the RLC layer at the PDCP layer until they are delivered at the other side (i.e., an acknowledgment is received, e.g., via the PDU status report) regardless of the RLC configuration (i.e., UM or AM). This way, for example, when some packets are backlogged and/or lost at the secondary RAN node, they can be retransmitted quickly from the master RAN node (i.e., MeNB, MgNB) that holds all PDCP PDUs until they are successfully delivered to UE. With current 3GPP standards for 5G-NR, only the PDCP PDUs, which are not sent to the lower layer, is kept in a PDCP transmission buffer, and a discardTimer dictates when they should be discarded. This mode of operation, which hold packets (i.e., PDCP SDUs and PDUs) in PDCP, may be activated when a split bearer is configured.

In one embodiment, the decision of whether to hold all PDCP PDUs at the PDCP entity can be made dynamically, and it can be different for UL and DL directions. For example, in the case of UL, this may not be a significant problem since RLCs of the different protocol stacks are in the same box (i.e., at UE), while in the case of the DL direction, RLCs are located in different places (i.e., moving back a bunch of PDCP PDUs from RLC to PDCP over X2/Xn interface incurs some delays).

An embodiment of the present disclosure may include adjusting the discardTimer at the PDCP layer dynamically according to an underlying network condition of the UE and its connectivity to base stations (i.e., MN and SN). Currently, the discardTimer is statically set by the master RAN node. For example, suppose the UE has good connectivity to base stations (both MN and SN) in a DC deployment. In that case, the value of the discardTimer does not need to be large either for UL or DL directions. Also, gNB does not need to allocate a large amount of memory to the PDCP entity (or if shared memory is used, a PDCP instance can't occupy a large fraction of it). However, if the UE has poor connectivity with at least one base station (e.g., SN), then the discardTimer may be set to a reasonably large value to prevent stored packets at the PDCP layer from being discarded (both PDCP PDUs already sent to lower layers or PDCP SDUs) so that fast inter-RAT retransmission can be done if needed. To this end this embodiment proposes to adjust the discardTimer dynamically according to the UE connectivity to RAN nodes (i.e., connected base stations in DC).

In one embodiment, the master RAN node dynamically determines the value of the discardTimer (or a similar control parameter used for DL) for the PDCP entity at the master RAN node according to measurement reports the UE sends to the master RAN node. The UE may be configured by the master RAN node with a set of required measurements in this regard.

In one embodiment, the master RAN node not only configures the discardTimer for the DL traffic but also for the UL traffic at the UE via RRC signaling. In one embodiment, the secondary RAN node takes responsibility of configuring discardTimer for the UE (for the UL direction) especially when SRB3 is available. In one embodiment, the UE determines a new value for the discardTimer for UL dynamically. In one embodiment, the UE may request the network (e.g., MN or SN) to configure the UE with the proposed value by UE. The network may accept or reject the UE request with an indication of the cause value.

In one embodiment for the uplink, the UE can autonomously adjust its discardTimer according to either radio characteristics of throughput characteristics. This can for instance be done by configuring a set of discardTimer values that can be used and thresholds related to each discardTimer value. As an example, the UE is configured with discardTimer values 50 ms and 100 ms and throughput threshold 100 mbit/s. If the throughput of a PDCP entity is larger than 100 mbit/s, the discardTimer value takes on the value 50 ms. In this embodiment, the network (e.g., 5GC or NG-RAN) may provide a policy to UE indicating these rules. If UE already has a local policy and also receives a policy from the network, the newly received policy may have the highest priority to follow.

An embodiment of the present disclosure may include generating the PDCP Status Report message from the receiving PDCP to the other side (e.g., from UE to MeNB), according to a new short timer after which a missing PDCP sequence number in the reception PDCP buffer is detected. With current 3GPP standards for 5G-NR, a missing PDCP sequence number can be detected and there is a timer that is responsible for delivering PDCP PDUs to the upper layer if missing SNs have not arrived before the timer is expired. This embodiment may include a new timer with a short duration activated upon a missing SN is detected. Once the new short timer is expired, a PDCP Status Report message is sent to the sending PDCP entity side (more specifically Master Ran node). The new proposed timer may have different responsibility than the current “t-Reordering” timer.

A PDCP Status Report may include all missing and acknowledged PDCP sequence numbers. This information can be indicated through bitmap fields or FMC fields of the PDCP Control PDU header. This way, the PDCP layer at the other side (i.e., sending PDCP) can realize which PDCP packets are missing, and which protocol stacks are those missing packets have been sent to.

An embodiment of the present disclosure may include holding extra information regarding the RLC layer each packet (i.e., PDCP PDU) has been forwarded to (like a scoreboard) at the PDCP layer. This way the PDCP layer always know which RLC entity each packet has gone through.

Overall, the PDCP Status Report messages combined with the RLC Buffer Status Report messages, RRC Measurement Report messages from UE, and DL Data Delivery Status that are exchanged between RAN nodes over the user plane (which provide several valuable feedbacks for DL and UL traffic flows to Master RAN node; see TS 38.425 V17.2.0 clause 5.4.2.1) will assist, the PDCP layer (at the base station) in deciding on strategies/policies to use to retransmit these missing packets (e.g., whether to perform inter-RAT retransition). An ML (machine learning) technique at the NG-RAN or base station or 5GC can be used to consume these inputs and determine how to perform inter-RAT retransmissions to recover missing sequence numbers at the receiver's reception buffer so that packets can flow faster to upper layers.

An embodiment of the present disclosure may include a new mechanism to trigger the removal of the backlogged data packets at a radio protocol stack (e.g., Sen-gNB) that have already been retransmitted via the other radio protocol stack (e.g., MeNB). This removal may be signaled via a Failure Information message over Xn/X2 interface (i.e., via CP) or a DL USER DATA message which a user plane signaling over Xn/X2 interface. Overall, this functionality has several benefits: (1) it saves radio resources, allowing other UEs with good connectivity to the BS (in this case, Sen-gNB) to transmit their data packets instead of using radio resources for unnecessary packet re-transmissions; and (2) it saves computational resources at both BSs and UE given that redundant packets do not need to be processed at both sides. This is particularly important for the backlogged PDCP SDUs, given that they should go through several computationally expensive operations at the PDCP, RLC and MAC layers before they become ready for transmission at the PHY layer.

Removing of the backlogged data packets at a radio protocol stack (e.g., Sen-gNB) may be triggered by the Assistant Information message, which is typically exchanged between RAN nodes over the user plane. The transfer of Assistant Information procedure may be invoked if the corresponding RAN node (e.g., SN) is configured to perform the QoS monitoring and to send the QoS monitoring results to the node hosting the NR PDCP entity (i.e., MN) for the concerned data radio bearer (see TS 38.425V17.2.0, clause 5.4.3.1).

An embodiment of the present disclosure may include monitoring the size of the RLC transmission buffer and when it exceeds a certain configurable threshold, an indication is sent to the PDCP layer indicating that the RLC buffer is building up. This may be a crucial feature because, typically, when the MAC layer is busy with re-transmitting lost packets, new incoming packets (PDCP PDUs) are stored in the RLC transmission buffer, and this may imply that the UE has poor connectivity with BS. When the PDCP layer is received such an indication it may decide to stop splitting traffic towards this BS, considering other feedbacks. Once the size of the RLC transmission buffer is drained, a reply indication can be generated to PDCP. These control messages should be delivered via X2/Xn interface between BSs. For example, the Assistant Information message may be extended to include such information. The Assistant Information message may include other information such as UL/DL delay (only supported for NR PDCP), Radio quality information such as average CQI, HARQ, HARQ Retransmission, DL Radio Quality Index, UL Radio Quality Index, etc.

In one example, the indication of the RLC transmission buffer can be a Buffer Status Report. In another example, the indication is triggered when the RLC transmission buffer is larger than a configured threshold. This can trigger the PDCP entity to not send down anymore data packets to the specific RLC entity.

The proposed embodiments in this present disclosure are also applicable to the 5G WLAN Aggregation technology and LTE WLAN Aggregation (LWA). In such scenarios the secondary RAN node could be Wi-Fi access point or a Wi-Fi controller managing multiple Wi-Fi access points (i.e., non-3GPP RAN node). A viable approach in these cases would be to use MCG Split Bearer, where part of the traffic can be split at the PDCP layer of the Master node (i.e., gNB/eNB) towards the UE's non-3GPP access. As a result, the master RAN node (e.g., gNB) can retransmit a set of packets, which have already been backlogged in the MAC layer's buffer of the Wi-Fi access point, by itself. Additional signaling may require for removing backlogged packets at non-3GPP protocol stacks.

FIG. 7 illustrates a flow chart of signaling procedures according to an embodiment of the present disclosure.

Signalling procedures in an EN-DC scenario with MCG Split Bearer may temporarily stop traffic splitting at PDCP. MeNB sends a request message to Sen-gNB to remove certain packets from its RLC buffer and stops retransmitting them at its MAC layer because MeNB wants to retransmit them through its protocol stack.

FIG. 7 illustrates a call flow, regarding how a Master RAN node (MeNB) in an EN-DC scenario with MCG Split Bearer can perform inter-RAT retransmission for a set of backlogged/lost packets at the Secondary RAN node (Sen-gNB). Similar signaling messages and procedures are valid under other DC variants such as NR-DC. In the following we discuss each operation in detail:

In Operation 1: Let's assume that UE is EN-DC capable and configured with MCG Split Bearer. MCG split bearer may be active. As a result, UE and MeNB can split incoming traffic across both RATs according to a vendor's traffic steering policies. In this example, we consider traffic splitting for the DL direction. Traffic may split at PDCP for DL. MeNB may send some traffic directly to UE while other portion are sent via Sen-gNB. Sen-gNB may relay received PDCP PDUs from MeNB to UE over a DRB.

In Operation 2: UE may send feedback messages (e.g., RRC Measurement Reports) related to MeNB and Sen-gNB to MeNB if SRB1 is configured. MeNB then may relay the Sen-gNB related feedback messages to Sen-gNB via the X2 interface. If an optional SRB3 is configured between UE and Sen-gNB, UE can send the Sen-gNB related feedback messages directly to Sen-gNB. In the latter case, it may be crucial to relay the Sen-gNB related feedback messages to MeNB via the X2 interface to allow MeNB to be aware of the connectivity status between UE and Sen-gNB (see Operation 2.1). Note that UE may send information regarding Sen-gNB to both MeNB and Sen-gNB nodes in parallel (see Operation 2.2).

Note: This feedback message could be an RRC Measurement Report message comprising several measurements from UE's PHY layer, including at least one of RSRP (reference signal received power), RSRQ (reference signal received quality) and Signal-to-Noise and Interference Ratio (SINR).

Note: SRBs may have higher priority than DRBs, so all these signaling messages can be delivered with high priority over the X2 interface (or Xn in the case of NR-DC).

In Operation 3: UE may detect a missing PDCP sequence number at its reception/reordering buffer, and a short timer may be activated immediately.

In Operation 3.1: Sen-gNB can also monitor its RLC transmission queue so that if its size exceeds a threshold, Sen-gNB notifies MeNB. When UE has poor connectivity to Sen-gNB, these conditions (Operations 3 & 3.1) might appear simultaneously with high probability.

In Operation 4: A new proposed timer is expired so a PDCP Status Report message may be sent to MeNB, indicating all the missing and acknowledged PDCP packets.

In Operation 4.1: A new message may be sent to MeNB, indicating that the RLC buffer is building up and it is about to overflow. Alternatively, when the buffer occupancy has exceeded a predefined threshold, the Sen-gNB may notify MeNB that RLC transmit queue exceeds a predefined threshold. This message can be delivered to MeNB either via XnAP or the DL Data Delivery Status (PDU Type 1; see TS 38.425 V17.2.0) message within a new field. The DL Data Delivery Status may include an NR User Plane signaling.

In Operation 5: By receiving these feedback messages from different entities over various messages (i.e., PDCP Status Report and RRC measurement report messages from UE, the RLC Buffer Status Report from Sen-gNB over X2, the Assistance Information message from Secondary RAN nodes over UP, and the DL Data Delivery Status message from Secondary RAN nodes over UP), MeNB can determine/predict that the connectivity between UE and Sen-gNB may be in poor condition, and thus the UE downlink traffic may be backlogged in the RLC transmit buffer of Sen-gNB. In such a condition, MeNB may determine to immediately stop splitting traffic further towards Sen-gNB. MeNB may also determine to adjust the discardTimer to a larger value.

AI/ML (Artificial Intelligence/machine learning) techniques may be used here for these determinations/predictions.

In Operation 6: MeNB may send a control message to Sen-gNB, via X2AP, asking RLC to remove certain packets from its transmission and/or retransmission buffers and the buffers at the MAC layer, and to stop retransmitting certain packets at the MAC layer. Alternatively, this signal to remove some sequence numbers (packets) can be sent over the DL USER DATA message from the Master RAN node.

In Operation 7: Immediately after the previous operation, MeNB may retransmit missing PDCP packets, previously sent to Sen-gNB, via its own protocol stack to UE. Also, all new DL traffic may be sent via this DRB.

Note: The newly proposed embodiment at the PDCP layer allows PDCP to detect which packets were previously sent to Sen-gNB which are now missing at the UE's reception/reordering buffer.

In Operation 8: Sen-gNB sends a confirmation message to MeNB via X2AP. The confirmation message may indicate that Sen-gNB deletes all requested packets by MeNB. The confirmation message may indicate that Sen-gNB stop retransmitting all requested packets at the MAC layer. A new RRC message like an RRC Connection Reconfiguration message, may be used and required to do this essentially to discard all pending packets across layers (e.g., at the MAC layer).

In Operation 9: UE received all missing packets in the reordering buffer (at the PDCP layer) so that now it can deliver them to the upper layer, and may send PDCP Status Report to the sending PDCP entity (i.e., MeNB in this example).

In Operation 10: UE may send feedback (e.g. measurement report) to MeNB via RRC signaling (over an SRB1. UE may send feedback to MeNB and Sen-gNB regularly. MeNB now decides that the connectivity between UE and Sen-gNB has returned to normal again.

MeNB then may relays the Sen-gNB related feedback to Sen-gNB. If an optional SRB3 is configured between UE and Sen-gNB, UE can send the Sen-gNB related feedback messages directly to Sen-gNB. UE may send information regarding Sen-gNB to both MeNB and Sen-gNB nodes in parallel.

In Operation 11: MeNB starts splitting traffic towards Sen-gNB again. MeNB may also adjust discard timer to a smaller value to same memory. With current 3GPP standards, packet duplication can't be done simultaneously with traffic splitting.

Although the embodiment has been shown and described, it will be appreciated by those skilled in the art that various changes and modifications might be made without departing from the scope of the disclosure, as defined in the appended claims and as described above.

For example, all proposed embodiments described herein are applicable to different variants of DC.

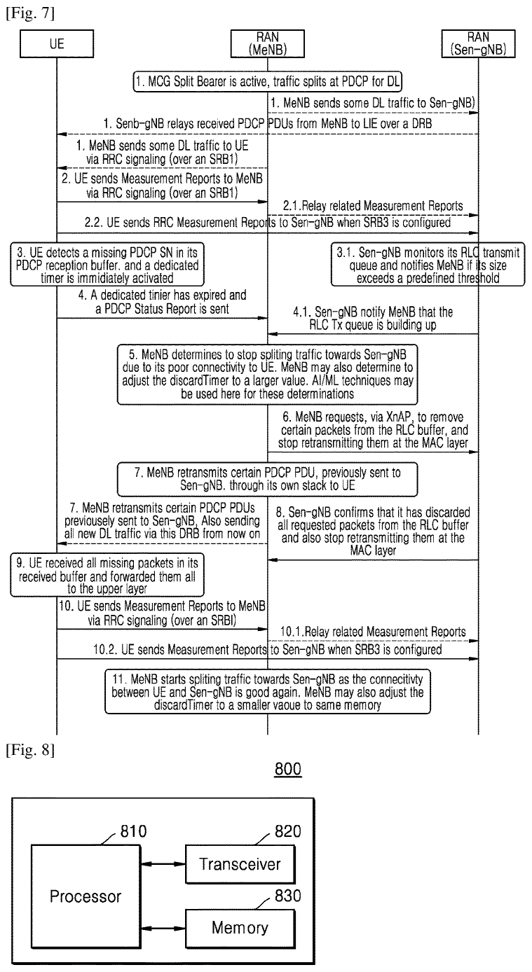

FIG. 8 illustrates a base station according to embodiments of the present disclosure.

Referring to the FIG. 8, the base station 800 may include a processor 810, a transceiver 820 and a memory 830. However, all of the illustrated components are not essential. The base station 800 may be implemented by more or less components than those illustrated in FIG. 8. In addition, the processor 810 and the transceiver 820 and the memory 830 may be implemented as a single chip according to another embodiment. The gNBs, eNBs, secondary nodes(SNs), master nodes (MNs), Sen-gNBs, MeNBs, networks or BSs described above may correspond to the base station 800.

The processor 810 may include one or more processors or other processing devices that control the proposed function, process, and/or method. Operation of the base station 800 may be implemented by the processor 810.

The transceiver 820 may include a RF transmitter for up-converting and amplifying a transmitted signal, and a RF receiver for down-converting a frequency of a received signal. However, according to another embodiment, the transceiver 820 may be implemented by more or less components than those illustrated in components.

The transceiver 820 may be connected to the processor 810 and transmit and/or receive a signal. The signal may include control information and data. In addition, the transceiver 820 may receive the signal through a wireless channel and output the signal to the processor 810. The transceiver 820 may transmit a signal output from the processor 810 through the wireless channel.

The memory 830 may store the control information or the data included in a signal obtained by the base station 800. The memory 830 may be connected to the processor 810 and store at least one instruction or a protocol or a parameter for the proposed function, process, and/or method. The memory 830 may include read-only memory (ROM) and/or random access memory (RAM) and/or hard disk and/or CD-ROM and/ or DVD and/or other storage devices.

According to an embodiment of the present disclosure, a master node (MN) in wireless communication system is provided. The MN may comprises at least one transceiver, and at least one processor coupled to the at least one transceiver. The at least one processor may be configured to identify whether to stop splitting one or more traffics towards a secondary node (SN) based on a received feedback message; and The at least one processor may be configured to stop splitting the one or more traffics towards the SN, in case that the feedback message indicates connection between a user equipment (UE) and the SN in poor condition.

The at least one processor may be configured to transmit, to the UE, one or more packets sent to the SN.

The at least one processor may be configured to receive, from the UE, the feedback message comprising a report indicating one or more missing packets. The at least one processor may be configured to transmit, to the SN, a request message requesting to remove the one or more missing packets and to stop transmitting the one or more missing packets.

The at least one processor may be configured to receive, from the SN, a message indicating that the SN deletes the one or more missing packets and stops transmitting the one or more missing packets.

The at least one processor may be configured to receive, from the SN, the feedback message comprising a message indicating radio link transmission queue exceeds a predefined threshold.

The at least one processor may be configured to receive, from the UE, a second feedback message. The at least one processor may be configured to start splitting the one or more traffics towards the SN.

The at least one processor may be configured to adjust a discardtimer based on the feedback message.

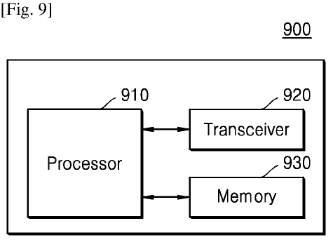

FIG. 9 illustrates a user equipment (UE) according to embodiments of the present disclosure.

The UEs described above may correspond to the UE 900. Referring to the FIG. 9, the UE 900 may include a processor 910, a transceiver 920 and a memory 930. However, all of the illustrated components are not essential. The UE 900 may be implemented by more or less components than those illustrated in FIG. 9. In addition, the processor 910 and the transceiver 920 and the memory 930 may be implemented as a single chip according to another embodiment.

The transceiver 920 may include a RF transmitter for up-converting and amplifying a transmitted signal, and a RF receiver for down-converting a frequency of a received signal. However, according to another embodiment, the transceiver 920 may be implemented by more or less components than those illustrated in components.

The transceiver 920 may be connected to the processor 910 and transmit and/or receive a signal. The signal may include control information and data. In addition, the transceiver 920 may receive the signal through a wireless channel and output the signal to the processor 910. The transceiver 920 may transmit a signal output from the processor 910 through the wireless channel.

The memory 930 may store the control information or the data included in a signal obtained by the UE 900. The memory 930 may be connected to the processor 910 and store at least one instruction or a protocol or a parameter for the proposed function, process, and/or method. The memory 930 may include read-only memory (ROM) and/ or random access memory (RAM) and/or hard disk and/or CD-ROM and/or DVD and/ or other storage devices.

The processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the operations of any method or process so disclosed, may be combined in any combination, except combinations where at least some of such features and/or operations are mutually exclusive.

Although the present disclosure has been described with an exemplary embodiment, various changes and modifications may be suggested to one skilled in the art. It is intended that the present disclosure encompass such changes and modifications as fall within the scope of the appended claims.

None of the description in this application should be read as implying that any particular element, operation, or function is an essential element that must be included in the claims scope. The scope of patented subject matter is defined only by the claims.

1. A method performed by a master node (MN) in wireless communication system, the method comprising:
identifying whether to stop splitting one or more traffics towards a secondary node (SN) based on a received feedback message; and
in case that the feedback message indicates connection between a user equipment (UE) and the SN in poor condition, stopping splitting the one or more traffics towards the SN.

2. The method of claim 1, further comprising:
transmitting, to the UE, one or more packets sent to the SN.

3. The method of claim 1, further comprising:
receiving, from the UE, the feedback message comprising a report indicating one or more missing packets; and
transmitting, to the SN, a request message requesting to remove the one or more missing packets and to stop transmitting the one or more missing packets.

4. The method of claim 3, further comprising:
receiving, from the SN, a message indicating that the SN deletes the one or more missing packets and stops transmitting the one or more missing packets.

5. The method of claim 1, further comprising:
receiving, from the SN, the feedback message comprising a message indicating radio link transmission queue exceeds a predefined threshold.

6. The method of claim 1, further comprising:
receiving, from the UE, a second feedback message; and
starting splitting the one or more traffics towards the SN.

7. The method of claim 1, further comprising:
adjusting a discardtimer based on the feedback message.

8. A master node (MN) in wireless communication system, the MN comprising:
at least one transceiver; and
at least one processor coupled to the at least one transceiver and configured to:
identify whether to stop splitting one or more traffics towards a secondary node (SN) based on a received feedback message; and
in case that the feedback message indicates connection between a user equipment (UE) and the SN in poor condition, stop splitting the one or more traffics towards the SN.

9. The MN of claim 8, wherein the at least one processor is configured to:
transmit, to the UE, one or more packets sent to the SN.

10. The MN of claim 8, wherein the at least one processor is further configured to:
receive, from the UE, the feedback message comprising a report indicating one or more missing packets; and
transmit, to the SN, a request message requesting to remove the one or more missing packets and to stop transmitting the one or more missing packets.

11. The MN of claim 10, wherein the at least one processor is further configured to:
receive, from the SN, a message indicating that the SN deletes the one or more missing packets and stops transmitting the one or more missing packets.

12. The MN of claim 8, wherein the at least one processor is further configured to:
receive, from the SN, the feedback message comprising a message indicating radio link transmission queue exceeds a predefined threshold.

13. The MN of claim 8, wherein the at least one processor is further configured to:
receive, from the UE, a second feedback message; and
start splitting the one or more traffics towards the SN.

14. The MN of claim 1, wherein the at least one processor is further configured to:
adjust a discardtimer based on the feedback message.
